(19) United States
(12) Patent Application Publication
(10) Pub. No.: US 2026/0191725 A1
(43) Pub. Date: Jul. 9, 2026

(54) MATTRESS FOR A SURGICAL TABLE

(71) Applicant: SHEBA IMPACT LTD., Ramat Gan (IL)

(72) Inventors: Hani ABD ELKARIM, Lod (IL); Arkadi KALONTAROV, Rosh Haain (IL)

(21) Appl. No.: 19/132,554

(22) PCT Filed: Nov. 23, 2023
(86) PCT No.: PCT/IL2023/051206

§ 371 Date: May 23, 2025

(30) Foreign Application Priority Data
Nov. 24, 2022 (IL) 298580

(51) Int. Cl. A61G 13/12; A47C 27/10

(52) U.S. Cl. CPC A61G 13/1265; A47C 27/10

(57) ABSTRACT

A mattress for a surgical table, the mattress constituted of: a plurality of inflatable members, each of the plurality of inflatable members comprising a respective cavity, wherein each of the plurality of inflatable members is inflatable by injection of inflation fluid into the cavity of the respective inflatable member; and a control circuitry, the inflation of each of the plurality of inflatable members separately responsive to an output of the control circuitry.

### TECHNICAL FIELD

The present disclosure relates substantially to the field of surgical procedures.

### BACKGROUND

A surgical table, also known as an operating table, is a table on which a patient lies during a surgical procedure. Surgical tables are typically used within an operating room or surgical suite of a hospital, ambulatory surgery center, or other healthcare facilities where surgeries are performed. Surgical tables may be either stationary or mobile to move room to room. Surgical tables are used in various types of procedures such as cardiothoracic, orthopedic, bariatric, robotic, urologic, and more. Typically, a mattress is placed on top of the surgical table, and the patient is positioned on the mattress.

### SUMMARY

Accordingly, it is a principal object of the present disclosure to overcome at least some of the disadvantages of prior art mattresses for surgical tables. This is provided in one example by a mattress for a surgical table, the mattress comprising: a plurality of inflatable members arranged in a 2-dimensional array, each of the plurality of inflatable members comprising a respective cavity, wherein each of the plurality of inflatable members is inflatable by injection of inflation fluid (air/liquid) into the cavity of the respective inflatable member; and a control circuitry, the inflation of each of the plurality of inflatable members separately responsive to an output of the control circuitry such that the inflation of the respective inflatable member is to a predetermined volume of 0.1-5 liters, wherein the 2-dimensional array exhibits a plurality of rows of the inflatable members and a plurality of columns of the inflatable members, a length of each row being greater than a length of each column.

In some examples, a distance between each adjacent pair of the plurality of rows is less than 10 centimeters.

Additional features and advantages of the invention will become apparent from the following drawings and description.

Unless otherwise defined, all technical and scientific terms used herein have the same meaning as commonly understood by one of ordinary skill in the art to which this invention pertains. In case of conflict, the patent specification, including definitions, governs. As used herein, the articles “a” and “an” mean “at least one” or “one or more” unless the context clearly dictates otherwise. As utilized herein, “and/or” means any one or more of the items in the list joined by “and/or”. As an example, “x and/or y” means any element of the three-element set {(x), (y), (x, y)}. In other words, “x and/or y” means “x, y or both of x and y”. As another example, “x, y, and/or z” means any element of the seven-element set {(x), (y), (z), (x, y), (x, z), (y, z), (x, y, z)}.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed devices and/or methods.

The following embodiments and aspects thereof are described and illustrated in conjunction with systems, tools and methods which are meant to be exemplary and illustrative, but not limiting in scope. In various embodiments, one or more of the above-described problems have been reduced or eliminated, while other embodiments are directed to other advantages or improvements.

### BRIEF DESCRIPTION OF DRAWINGS

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice. In the accompanying drawings:

FIGS. 1A-1C illustrate various high-level views of a mattress for a surgical table, comprising a plurality of inflatable members, in accordance with some examples of the present disclosure;

FIG. 1D illustrates a high-level top view of the mattress of FIGS. 1A-1C, further comprising a control circuitry and an inflation unit, in accordance with some examples of the present disclosure;

FIG. 1E illustrates a high-level top view of the mattress of FIG. 1D, further comprising a user input terminal and user notification terminal, in accordance with some examples of the present disclosure;

FIG. 1F illustrates a high-level top view of the mattress of FIG. 1E, further comprising sensors, in accordance with some examples of the present disclosure;

FIGS. 1G-1H illustrate various high-level top views of the mattress of FIG. 1E, further comprising one or more temperature adjustment mechanisms, in accordance with some examples of the present disclosure;

FIGS. 1I-1J illustrates various high-level perspective views of exemplary pump arrangements, in accordance with some examples of the present disclosure;

FIG. 2 illustrates a high-level flow chart of various steps performed by a control circuitry of the mattress of FIGS. 1A-1H, in accordance with some examples of the disclosure;

FIG. 3 illustrates a high-level top view of a mattress for a surgical table, comprising a plurality of inflatable members arranged in a 2-dimensional array and a headrest member, in accordance with some examples of the disclosure;

FIGS. 4A-4C illustrate various views of an exemplary shape of the plurality of inflatable members of FIGS. 1-3; and

FIG. 5 illustrates a high-level top view of a mattress for a surgical table comprising a plurality of layers, in accordance with some examples of the disclosure.

### DETAILED DESCRIPTION OF CERTAIN EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts throughout. In order to avoid undue clutter from having too many reference numbers and lead lines on a particular drawing, some components will be introduced via one or more drawings and not explicitly identified in every subsequent drawing that contains that component.

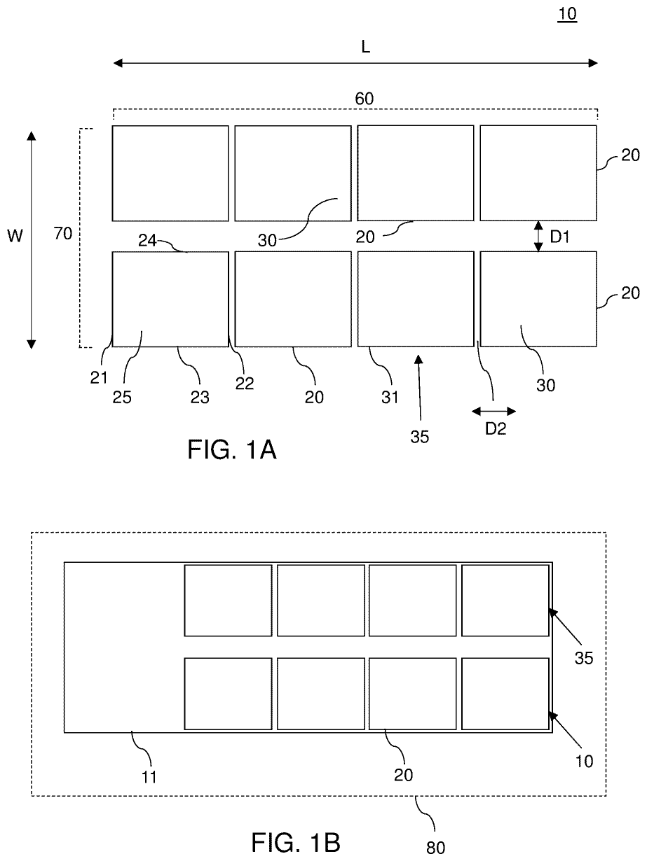

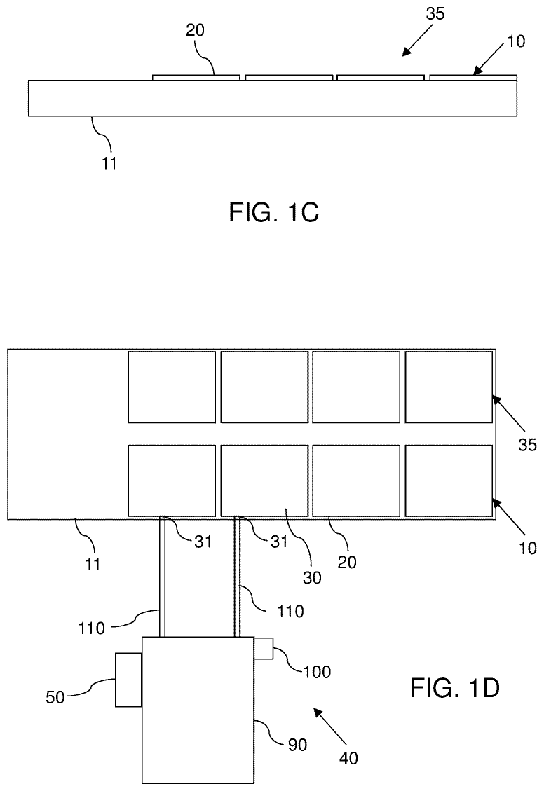

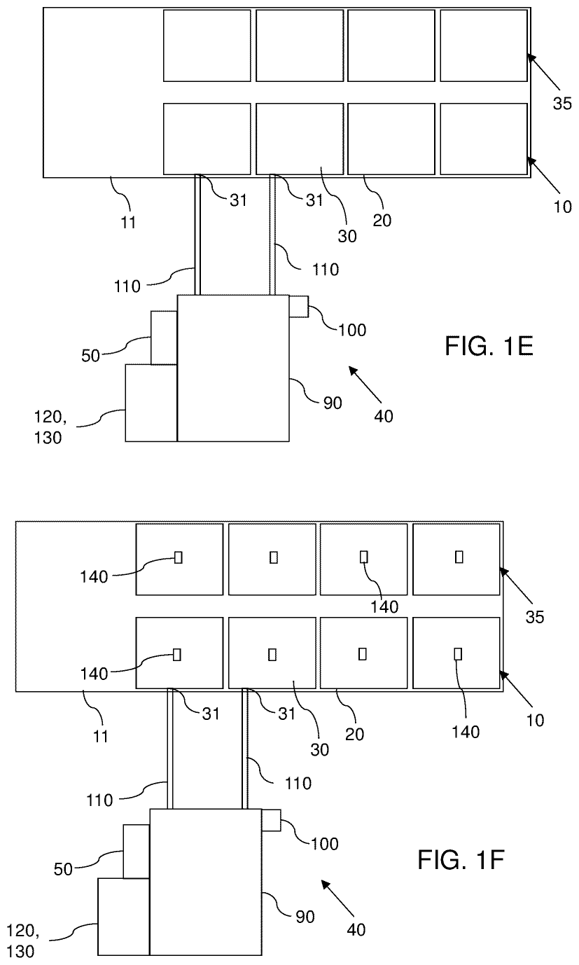

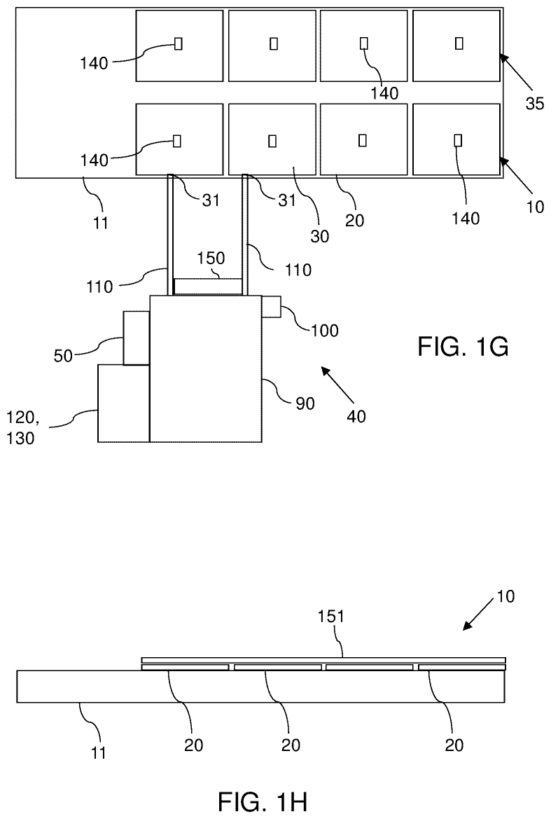

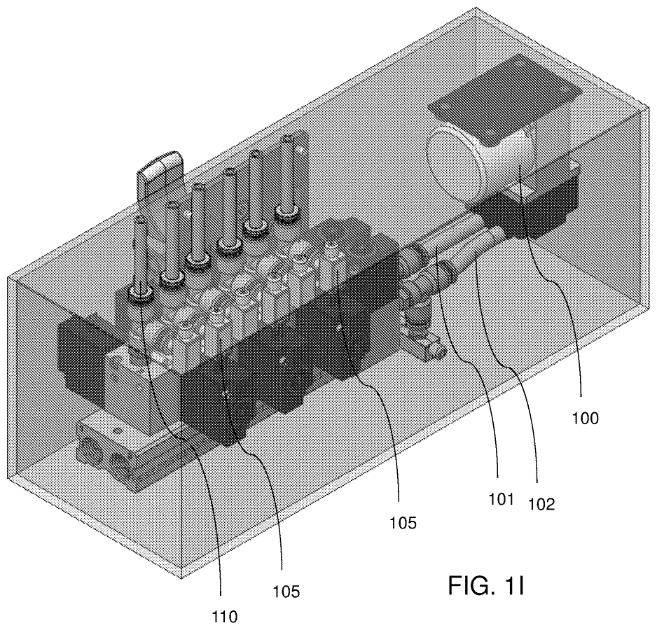

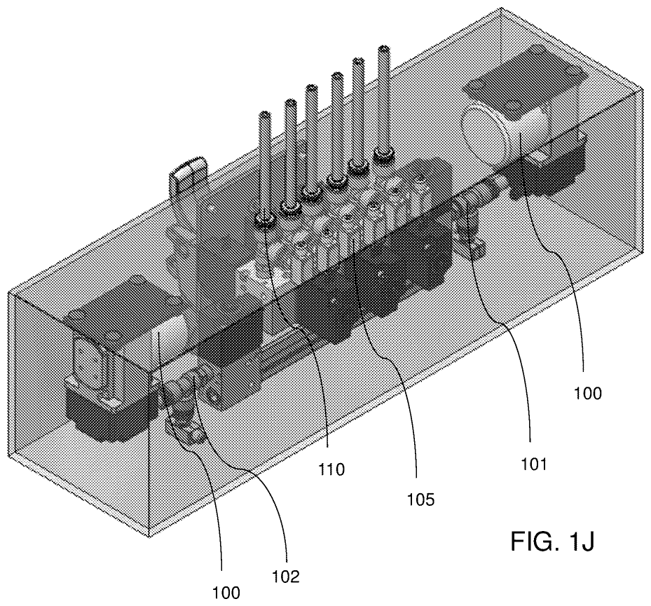

FIG. 1A illustrates a high-level top view of a mattress 10 for a surgical table 11, in accordance with some examples. FIG. 1B illustrates the high-level top view of mattress 10 when positioned on surgical table 11. FIG. 1C illustrates a high-level side view of mattress 10 when positioned on surgical table 11. The term “mattress”, as used herein, is meant to describe the purpose thereof, i.e. that it is used for supporting a patient atop a table or bed. The term as used is not meant to include any structural limitations.

In some examples, mattress 10 comprises a plurality of inflatable members 20, each inflatable member 20 comprising a respective cavity 30. Although inflatable members 20 are each illustrated and described herein as comprising a single cavity 30, this is not meant to be limiting in any way, and each inflatable member 20 can comprise any number of cavities 30. In some examples, each inflatable member 20 comprises one or more openings 31, openings 31 providing a fluid flow path from outside of the inflatable members 20 into cavities 30. The term “fluid flow path”, as used herein, means a path allowing fluid to flow therethrough.

In some examples, as illustrated in FIG. 1D, mattress 10 comprises an inflation unit 40 and a control circuitry 50. Particularly, FIG. 1D illustrates a high-level top view of mattress 10 including inflatable members 20, control circuitry 50 and inflation unit 40.

In some examples, each inflatable member 20 is inflatable by injection of inflation fluid 15 in the respective cavity 30. In some examples, inflation fluid 15 comprises one or more liquids, such as water. In some examples, inflation fluid 15 comprises one or more gasses, such as air. In some examples, inflation fluid 15 comprises a combination of one or more gasses and one or more liquids.

In some examples, each inflatable member 20 exhibits a first end 21 and a second end 22, second end 22 opposing first end 21. In some examples, each inflatable member 20 exhibits a first side 23 and a second side 24, second side 24 opposing first side 23. In some examples, each inflatable member 20 exhibits an upper face 25 and a lower face 26, lower face 26 opposing upper face 25. In some examples, cavity 30 is surrounded by first end 21, second end 22, first side 23, second side 24, upper face 25 and lower face 26.

In some examples, for each inflatable member 20, the distance between first end 21 and second end 22 (i.e., the length of inflatable member 20) is greater than the distance between first side 23 and second side 24 (i.e., the width of inflatable member 20). In some examples, each inflatable member 20 is generally rectangular shaped. In some examples, each inflatable member 20 is generally tubular shaped. In some examples, each inflatable member 20 is generally rectangular shaped when deflated and generally tubular shaped when inflated. In some examples, a diameter of inflatable member 20 when deflated is about 70-90 centimeters, and the diameter of inflatable member 20 when fully inflated is about 40-60 centimeters. In some examples, a diameter of inflatable member 20 when deflated is about 80 centimeters, and the diameter of inflatable member 20 when fully inflated is about 50 centimeters.

In some examples, inflatable members 20 are arranged in a 2-dimensional array 35. The term “2-dimensional array”, as used herein, means an array with a plurality of columns and a plurality of rows. It is noted that the term “2-dimensional array” is not meant to be limiting to only 2 dimensions, and a 3-dimensional array comprising a plurality of 2-dimensional arrays 35 can be provided without exceeding the scope of the disclosure. Thus, in some examples, mattress 10 comprises a plurality of rows 60 (marked in FIG. 1A by dotted lines) of inflatable members 20 and a plurality of columns 70 (marked in FIG. 1A by dotted lines) of inflatable members 20. In some examples, 2-dimensional array 35 is generally rectangular shaped. In some examples, 2-dimensional array 35 defines a plane 80, plane 80 parallel to surgical table 11.

In some examples, plurality of rows 60 consists of two or three rows. In some examples, plurality of rows 60 consists of two rows. In some examples, plurality of rows 60 consists of three rows. In some examples, plurality of columns 70 consists two to four columns. In some examples, plurality of columns 70 consists of two columns. In some examples, plurality of columns 70 consists of three columns. In some examples, plurality of columns 70 consists of four columns.

In some examples, the length of each row 60 is greater than the length of each column 70 of 2-dimensional array 35. The length of each row 60, denoted L, is defined from first end 21 of the first inflatable member 20 of the respective row 60 to second end 22 of the ultimate inflatable member 20 of the respective row 60. In some examples, length L is 80-250 centimeters. In some examples, length L is 85-120 centimeters. Particularly, in some examples, 2-dimensional array 35 does not cover the entire length of surgical table 11. In some examples, as will be described below, an additional inflatable member is provided to support the head of the patient and length L of 2-dimensional array 35 is 85-95 centimeters. In some examples, length L is about 90 centimeters.

In some examples, length L of 2-dimensional array 35 is shorter than the length of surgical table 11. In some examples, as will be described below, a headrest member is further provided, and optionally the combined length of 2-dimensional array 35 and the headrest member is shorter than the length of surgical table.

In some examples, the length of each column 70, denoted W (i.e. the width of the 2-dimensional array), is defined from first side 23 of the first inflatable member 20 of the respective column 70 to second side 24 of the ultimate inflatable member 20 of the respective column 70. In some examples, width W is 50-60 centimeters. In some examples, width W is 50-55 centimeters. In some examples, width W is about 53 centimeters.

In some examples, the distance between each adjacent pair of rows 60 of inflatable members 20, denoted D1, is less than 10 centimeters. In some examples, distance D1 between each adjacent pair of rows 60 of inflatable members 20 is 5-9 centimeters. In some examples, distance D1 between each adjacent pair of rows 60 of inflatable members 20 is 6-8 centimeters. In some examples, distance D1 between each adjacent pair of rows 60 of inflatable members 20 is about 7 centimeters. In some examples, distance D1 between each adjacent pair of rows 60 of inflatable members 20 is 1.5-2.5 centimeters. In some examples, distance D1 between each adjacent pair of rows 60 of inflatable members 20 is about 2 centimeters.

In some examples, the distance between each adjacent pair of columns 70 of inflatable members 20, denoted D2, is less than 5 centimeters. In some examples, distance D2 between each adjacent pair of columns 70 of inflatable members 20 is 1-3 centimeters. In some examples, distance D2 between each adjacent pair of columns 70 of inflatable members 20 is about 2 centimeters.

In some examples, the length of each inflatable member 20 is 20-70 centimeters. In some examples, the length of each inflatable member 20 is 25-35 centimeters. In some examples, the length of each inflatable member 20 is about 30 centimeters. In some examples, the difference between lengths of the different inflatable members 20 is less than 10%.

In some examples, the width of each inflatable member 20 is 15-40 centimeters. In some examples, the width of each inflatable member 20 is 15-25 centimeters. In some examples, the width of each inflatable member 20 is about 20 centimeters. In some examples, the difference between widths of the different inflatable members 20 is less than 10%. In some examples, the width of each inflatable member 20 is about 20 centimeters and the length of each inflatable member 20 is about 30 centimeters.

In some examples, the volume of cavity 30 of each inflatable member 20 when the respective inflatable member 20 is maximally inflated is at least two liters. The term “maximally inflated”, as used herein, means that cavity 30 is filled with inflation fluid 15 to the maximal amount defined by the manufacture as the maximum volume. In some examples, where each inflatable member 20 comprises a plurality of cavities 30, the combined volumes of the respective plurality of cavities 30 when the respective inflatable member 20 is maximally inflated is at least two liters.

In some examples, the volume of cavity 30 (or the combined volumes of cavities 30) of each inflatable member 20 when the respective inflatable member 20 is maximally inflated is about 3 liters. In some examples, the difference between the volumes of the cavities 30 of the different inflatable members 20 when maximally inflated is less than 10%. Thus, in such examples, if the volume of cavity 30 (or combined volumes of cavities 30) of one inflatable member 20 when maximally inflated is 3 liters, then the volume of cavity 30 (or combined volumes of cavities 30) of any other inflatable member 20 is no less than 2.7 liters and no greater than 3.3 liters.

In some examples, the cavity 30 of each inflatable member 20 is controlled (as will be described below) to be inflated to a volume of 0.1-5 liters. In some examples, the cavity 30 of each inflatable member 20 is controlled to be inflated to a volume of 0.1-2 liters. In some examples, the cavity 30 of each inflatable member 20 is controlled to be inflated to a volume of 0.1-2 liters while the volume when maximally inflated is 3 liters.

In some examples, the height of each inflatable member 20 when maximally inflated is about 10 centimeters. In some examples, the height of each inflatable member 20 is controlled (as will be described below) to be up to about 10 centimeters (regardless of the maximal height achievable by the respective inflatable member 20). In some examples, the height of each inflatable member 20 is controlled to be about 2-10 centimeters. In some examples, the height of each inflatable member 20 when maximally inflated is about 2-10 centimeters. In some examples, the height of each inflatable member 20 when maximally inflated is about 4-6 centimeters. In some examples, the height of each inflatable member 20 when maximally inflated is about 5 centimeters. The height of the inflatable member 20 is defined as the distance between a current vertical position of upper face 25 and the vertical position of upper face 25 when no inflation fluid 15 has been injected into the respective inflatable member 20. In some examples, this will translate into a maximum patient tilt of 22 degrees, as will be described below.

In some examples, control circuitry 50 comprises any, or a combination of: an integrated circuit, such as a field-programmable gate array (FPGA); a microprocessor; a microcontroller; or other suitable circuitry. In some examples, at least a portion control circuitry 50 comprises computer software executed on a computer. In some examples, control circuitry 50 comprises a dedicated memory, or a portion of a computer memory. In some examples, control circuitry 50 is in communication with inflation unit 40. The communication can be wireless or wired. In some examples, as will be described further below, control circuitry 50 is in communication with additional elements, such as sensors and/or temperature adjustment elements. The communication can be wireless or wired. In some examples, control circuitry 50 is powered by an external or internal power source (not shown).

In some examples, inflation unit 40 comprises: an inflation fluid reservoir 90 containing inflation fluid 15; one or more pumps 100; and a plurality of flow members 110. Flow members 110 provide a fluid flow path therethrough. As described above, inflation fluid 15 can be one or more gasses, one or more liquids, or a combination thereof.

In some examples, each flow member 110 is tubular shaped. In some examples, a first end of each flow member 110 connected to inflation fluid reservoir 90 and a second end of each flow member 110 connected to an opening 31 of a respective cavity 30. Although only 2 flow members 110 are illustrated (for clarity), this is not meant to be limiting in any way. In some examples, the first ends of flow members 110 form a common fluid flow path, and adjustable valves are provided within each flow member 110 to individually select separate fluid flow paths from inflation fluid reservoir 90 to cavities 30.

Although inflation unit 40 is illustrated and described as having a single inflation fluid reservoir 90, this is not meant to be limiting in any way. In some examples, inflation unit 40 comprises a plurality of inflation fluid reservoirs 90, each fluidly connected to a respective cavity 30 by a respective flow member 110. The term “fluidly connected”, as used herein, means that the elements are connected via a respective fluid flow path thereby allowing fluid to flow from one element to another.

In some examples, the one or more pumps 100 are controlled by control circuitry 50 to pump inflation fluid from inflation fluid reservoir 90 through flow members 110 and into cavities 30 of inflatable members 20. In some examples, the inflation of inflatable member 20 is separately responsive to an output of control circuitry 50. In some examples, control circuitry 50 separately controls the one more pumps 100 to individually inflate each inflatable member 20 with a respective volume of inflation fluid 15. Thus, each inflatable member 20 can be inflated at different times, and to different volumes.

In some examples, control circuitry 50 controls the inflation of each inflatable member 20 such that a respective area of a patient supported by the respective inflatable member 20 is tilted at a respective tilt angle. The term “tilt angle”, as used herein, means an angle at which the patient is tilted in relation to a surgical table 11 when mattress 10 is positioned on surgical table 11. Particularly, when an inflatable member 20 is inflated, upper face 25 thereof rises, thereby raising the respective area of the patient. The volume of inflation fluid 15 injected into cavity 30 of the respective inflatable member 20 will define the height to which upper face 25 rises, and the height of upper face 25 will determine the tilt angle of the respective area of the patient. In some examples, the tilt angle is 5-22 degrees. Particularly, in some examples, control circuitry 50 controls the amount of inflation fluid 15 injected into the respective inflatable member 20 in order to achieve the desired tilt angle.

In some examples, as illustrated in FIG. 1E, mattress 10 comprises a user input terminal 120 and a user notification terminal 130. Particularly, FIG. 1E illustrates a high-level top view of mattress 10 comprising inflatable members 20, inflation unit 40, control circuitry 50, user input terminal 120 and user notification terminal 130. Although user input terminal 120 and user notification terminal 130 are illustrated and described herein together, this is not meant to be limiting in any way. In some examples, user input terminal 120 can be provided without user notification terminal 130 and in some examples, user notification terminal 130 can be provided without user input terminal 120.

In some examples, user input terminal 120 comprises any, or a combination of, a touch screen, a keyboard or a pointing device, such as a mouse. In some examples, user input terminal 120 comprises a network connection or other communication terminal configured to receive input from an external device or network. In some examples, user notification terminal 130 comprises any, or a combination of, a screen, a lighting display (e.g. LED indicator lights) or an audio device (e.g. a speaker). In some examples, user notification terminal 130 comprises a network connection or other communication terminal configured to output data to an external device or network. In some examples, user input terminal 120 and user notification terminal 130 are the same.

In some examples, the inflation of inflatable members 20 is controlled responsive to one or more user inputs received at user input terminal 120. In some examples, control circuitry 50 has stored on the memory thereof instructions regarding a predetermined tilt plan. The term “tilt plan”, as used herein, means a predetermined sequence of inflations and deflations of predetermined inflatable members 20, including the amount of time that each inflatable member 20 is to be inflated and the volume of inflation fluid 15 to be injected into each inflatable member 20.

In some examples, the predetermined tilt plan is entered at user input terminal 120. In some examples, tilt plan parameters are entered at user input terminal 120 and control circuitry 50 defines the tilt plan. In some examples, tilt plan parameters include any, or a combination, of: patient information, such as age, weight, medical history and/or known conditions that make the patient more susceptible to pressure ulcers; length of surgery; and positions of the patient during the surgery.

In some examples, each inflatable member 20 is inflated in response to a respective input at user input terminal 120. Particularly, when a technician, nurse, or surgeon wants to tilt the patient in a certain way, they provide a respective input at user input terminal 120, and responsive thereto control circuitry 50 controls pump 100 to inflate the respective inflatable member 20, as further described below. In some examples, the amount of inflation is further determined in response to the user input.

In some examples, responsive to a respective user input, control circuitry 50 is configured to prevent the inflation of a respective at least one inflatable member 20. Particularly, in accordance with predetermined parameters, one or more areas of the patient are designated as areas that should not be tilted, thus control circuitry 50 prevents inputs at user input terminal 120 from causing inflation of the inflatable member 20 associated with that area. In some examples, the area of the patient is an area that is being operated on.

In some examples, responsive to a respective user input at user input terminal 120, control circuitry 50 is configured to limit an inflation volume of a respective at least one inflatable member 20 to a respective upper threshold value. In some examples, the respective threshold value is greater than zero. Particularly, as described above, in some examples the amount of inflation is set by user inputs during a procedure. Thus, control circuitry 50 limits the amount of inflation fluid 15 that can be injected into the respective inflatable member 20 to the respective upper threshold value so that the associated portion of the patient isn't tilted at too great an angle.

In some examples, responsive to a respective user input at user input terminal 120, control circuitry 50 is configured to prevent the inflation of one or more inflatable members 20 during a predetermined time period, such as during a particular portion of the surgery. In some examples, a plurality of time periods are defined for the surgery and control circuitry 50 can be set to prevent each inflatable member 20 from being inflated during a respective time period.

In some examples, as illustrated in FIG. 1F, mattress 10 comprises a plurality of sensors 140. Particularly, FIG. 1F illustrates a high-level top view of mattress 10 comprising inflatable members 20, inflation unit 40, control circuitry 50, user input terminal 120, user notification terminal 130 and sensors 140. Although user input terminal 120, user notification terminal 130 and sensors 140 are illustrated together, this is not meant to be limiting in any way. In some examples, each of user input terminal 120, user notification terminal 130 and sensors 140 can be provided without the other.

In some examples, sensors 140 comprises any, or a combination, of: humidity sensors; temperature sensors; pressure sensors; or blood perfusion sensors. In some examples, each blood perfusion sensors 140 comprises a laser-doppler flowmetry sensor. In some examples, each blood perfusion sensor comprises an ultrasound transducer. In some examples, the number of humidity sensors 140 is at least the number of inflatable members 20. In some examples, each humidity sensor 140 is juxtaposed with a respective inflatable member 20. The term “juxtaposed”, as used herein, means that it is positioned in a predetermined relationship with the respective inflatable member 20. In some examples, each humidity sensor 140 can be placed on or near any appropriate section of the respective inflatable member 20. Although sensors 140 are illustrated herein as being positioned around at the center of the respective inflatable members 20, this is not meant to be limiting in any way.

In some examples, responsive to the outputs of the humidity sensors 140, control circuitry 50 adjusts the inflation of inflatable members 20. Particularly, an increase in humidity increases the risk of pressure ulcers. Thus, responsive to an increase in the humidity in a respective humidity sensor 140, control circuitry 50 increases the frequency of adjustment of the inflation of the respective inflatable member 20 associated with the respective humidity sensor 140. Thus, the tilt position of the area of the patient that exhibits increased humidity will be adjusted more often.

In some examples, the number of temperature sensors 140 is at least the number of inflatable members 20. In some examples, each temperature sensor 140 is juxtaposed with a respective inflatable member 20. In some examples, each temperature sensor 140 can be placed on or near any appropriate section of the respective inflatable member 20.

In some examples, responsive to the outputs of the temperature sensors 140, control circuitry 50 adjusts the inflation of inflatable members 20. Particularly, an increase in temperature increases the risk of pressure ulcers. Thus, responsive to an increase in the temperature in a respective temperature sensor 140, control circuitry 50 increases the frequency of adjustment of the inflation of the respective inflatable member 20 associated with the respective temperature sensor 140. Thus, the tilt position of the area of the patient that exhibits increased temperature will be adjusted more often.

In some examples, the number of pressure sensors 140 is at least the number of inflatable members 20. In some examples, each pressure sensor 140 is juxtaposed with a respective inflatable member 20. In some examples, each pressure sensor 140 can be placed on or near any appropriate section of the respective inflatable member 20.

In some examples, responsive to the outputs of the pressure sensors 140, control circuitry 50 adjusts the inflation of inflatable members 20. Particularly, an increase in pressure increases the risk of pressure ulcers. Thus, responsive to an increase in the pressure in a respective pressure sensor 140, control circuitry 50 increases the frequency of adjustment of the inflation of the respective inflatable member 20 associated with the respective pressure sensor 140. Thus, the tilt position of the area of the patient that exhibits increased pressure will be adjusted more often.

In some examples, the number of blood perfusion sensors 140 is at least the number of inflatable members 20. In some examples, each blood perfusion sensor 140 is juxtaposed with a respective inflatable member 20. In some examples, each blood perfusion sensor 140 can be placed on or near any appropriate section of the respective inflatable member 20.

In some examples, responsive to the outputs of the blood perfusion sensors 140, control circuitry 50 adjusts the inflation of inflatable members 20. Particularly, a decrease in blood perfusion increases the risk of pressure ulcers. Thus, responsive to an decrease in the blood perfusion in a respective humidity sensor 140, control circuitry 50 increases the frequency of adjustment of the inflation of the respective inflatable member 20 associated with the respective blood perfusion sensor 140. Thus, the tilt position of the area of the patient that exhibits decreased blood perfusion will be adjusted more often.

In some examples, as illustrated in FIGS. 1G and 1H, mattress 10 comprises one or more temperature adjustment mechanisms 150. Particularly, FIG. 1G illustrates a high-level top view of mattress 10 comprising inflatable members 20, inflation unit 40, control circuitry 50, user input terminal 120, user notification terminal 130, sensors 140 and a first example of temperature adjustment mechanism 150. FIG. 1H illustrates a high-level side view of mattress comprising inflatable members 20 and a second example of temperature adjustment mechanism 150.

Although user input terminal 120, user notification terminal 130, sensors 140 and temperature adjustment mechanism 150 are illustrated together, this is not meant to be limiting in any way. In some examples, each of user input terminal 120, user notification terminal 130, sensors 140 and temperature adjustment mechanism/s 150 can be provided without the other.

In some examples, temperature adjustment mechanism 150 comprises a heating device. In some examples, temperature adjustment mechanism 150 comprises a cooling device. In some examples, temperature adjustment mechanism 150 comprises both a heating device and a cooling device. In some examples, the heating device and/or cooling device of temperature adjustment mechanism 150 comprises a heat exchanger. In some examples, the heating device of temperature adjustment mechanism 150 comprises a heating element that converts electrical energy into heat, optionally through resistive heating.

In some examples, inflation fluid reservoir 90 comprises a cooling device configured to cool inflation fluid 15 to a predetermined temperature, and a heating device of temperature adjustment mechanism 150 is utilized to heat inflation fluid 15 to a desired temperature. In some examples, inflation fluid reservoir 90 comprises a heating device configured to heat inflation fluid 15 to a predetermined temperature, and a cooling device of temperature adjustment mechanism 150 is utilized to cool inflation fluid 15 to a desired temperature.

In some examples, a plurality of temperature adjustment mechanisms 150 are provided, each temperature adjustment mechanism 150 associated with a respective one of a plurality of flow members 110. In some examples, the temperature of inflation fluid 15 can be individually controlled for each flow member 110.

In some examples, a plurality of temperature adjustment mechanisms 150 are provided, each temperature adjustment mechanism 150 associated with a respective inflatable member 20. In some examples, each temperature adjustment mechanism 150 is attached to a surface of the respective inflatable member 20.

In some examples, as illustrated in FIG. 1H, the one or more temperature adjustment mechanisms 150 comprises a housing 151. In some examples, the length and width of housing 151 are generally equal to the length and width of 2-dimensional array 35 of inflatable members 20. In some examples, the one or more temperature adjustment mechanisms 150 are contained within housing 151. In some examples, housing 151 contains a fluid flowing therethrough, and a temperature adjustment mechanism is configured to heat and cool the fluid as required. In some examples, the fluid comprises inflation fluid 15 from inflation fluid reservoir 90.

In some examples, control circuitry 50 controls temperature adjustment mechanisms 150 responsive to respective outputs of sensors 140. In some examples, control circuitry 50 controls a respective temperature adjustment mechanism 150 to cool a respective area when a respective humidity sensor 140 senses an increase in humidity above a respective predetermined threshold, when a respective temperature sensor 140 senses an increase in temperature above a respective predetermined threshold, when a respective pressure sensor 140 senses an increase in pressure above a respective predetermined threshold and/or when a respective blood perfusion sensor senses a decrease in perfusion below a respective predetermined threshold.

FIG. 1I illustrates a high-level perspective view of an arrangement comprising a single pump 100. In some examples, a fluid inlet pipe 101 and a fluid outlet pipe 102 extend from pump 100. In some examples, each flow member 110 is secured to a respective valve 105. In some examples, each valve 105 is controlled by control circuitry 50. In some examples, pump 100 pumps fluid out through fluid outlet pipe 102 into the flow members whose respective valves 105 are open, thereby inflating the respective inflatable members 20 (not shown in FIG. 1I). Similarly, in order to deflate one or more inflatable members 20, pump 100 pumps fluid out of the respective inflatable members 20 whose respective valves 105 are open.

FIG. 1J illustrates a high-level perspective view of an arrangement comprising 2 pumps 100. In some examples, the arrangement of FIG. 1J is in all respects to the arrangement of FIG. 1I, with the exception that fluid inlet pipe 101 extends from a first pump 100 and fluid outlet pipe 102 extends from a second pump 100. Thus, the inflation and deflation of inflatable members 20 are controlled by separate pumps 100.

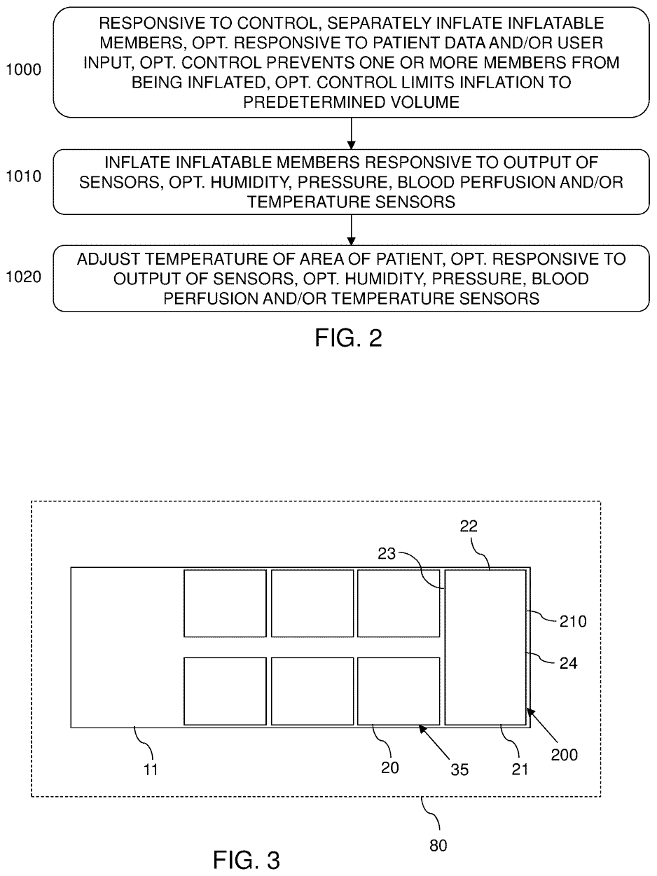

FIG. 2 illustrates a high-level flow chart of some examples of various steps performed by control circuitry 50. In step 1000, responsive to control circuitry 50, inflatable members 20 are separately inflated, as described above. In some examples, as described above, the inflation is responsive patient data. In some examples, as described above, the inflation is responsive to one or more user inputs. In some examples, as described above, control circuitry 50 prevents one or more inflatable members 20 from being inflated. In some examples, as described above, control circuitry 50 limits the volume of inflation of one or more inflatable members 20.

In step 1010, as described above, the inflation is responsive to outputs of a plurality of sensors. In some examples, the plurality of sensors comprises any, or a combination, of humidity sensors, pressure sensors, blood perfusion sensors or temperature sensors.

In step 1020, the temperature a respective area of a patient is adjusted. In some examples, as described above, the temperature adjustment is responsive to outputs of a plurality of sensors. In some examples, the plurality of sensors comprises any, or a combination, of humidity sensors, pressure sensors, blood perfusion sensors or temperature sensors.

FIG. 3 illustrates a high-level top view of a mattress 200, in accordance with some examples. Mattress 200 is in all respects similar to mattress 10, with the exception that in some examples mattress 200 comprises a 2-dimensional array 35 of inflatable members 20 and a headrest member 210. In some examples, 2-dimensional array 35 extends away from headrest member 210. In some examples, headrest member 210, along with 2-dimensional array 35, defines plane 80.

In some examples, a length of headrest member 210, defined from first end 21 to second end 22, is 50-60 centimeters. In some examples, the length of headrest member 210 is 50-55 centimeters. In some examples, the length of headrest member 210 is about 53 centimeters. In some examples, the width of headrest member 210, defined from first side 23 to second side 24, is 20-30 centimeters. In some examples, the width of headrest member 210 is 22-26 centimeters. In some examples, the width of headrest member 210 is about 24 centimeters.

In some examples, the length of headrest member 210 extends along the width of 2-dimensional array 35 and the width of headrest member 210 is an extension of the length of 2-dimensional array 35.

In some examples, as described above, the combination of the length of 2-dimensional array 35 and the width of headrest member 210 is shorter than the length of surgical table 11. Thus, in such examples, a portion of the patient's legs may not be supported by inflatable members 20.

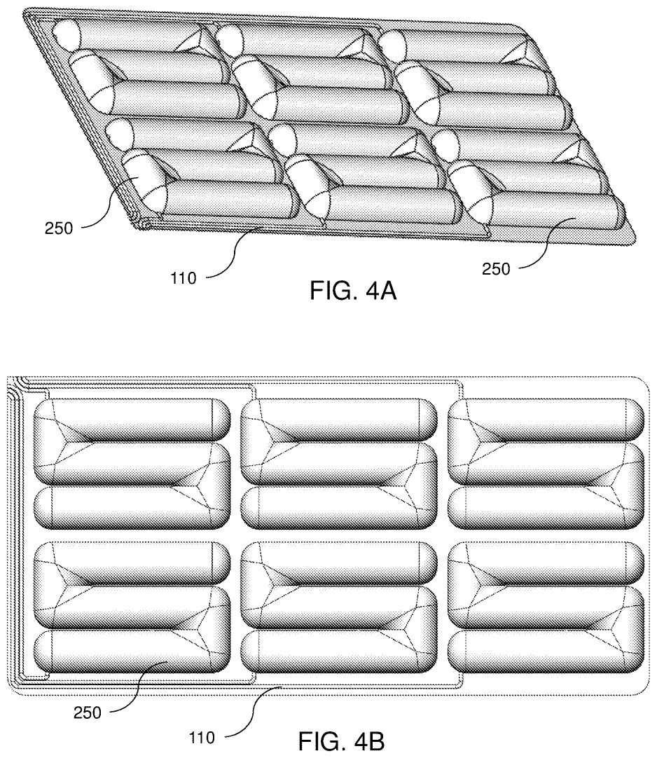

FIG. 4A illustrates a perspective view of a plurality of inflatable members 250 arranged in a 2-dimensional array. FIG. 4B illustrates a top view of the inflatable members 250. FIG. 4C illustrates an enlarged view of a portion of the 2-dimensional array of FIGS. 4A and 4B. In some examples, each inflatable member 250 is in all respects similar to inflatable member 20, with the exception that inflatable member 250 is generally S-shaped. As described above, in some examples, each inflatable members 250 exhibits a tubular shaped cross-section when inflated. As described above, each inflatable member 250 is in fluid communication with a respective flow member 110.

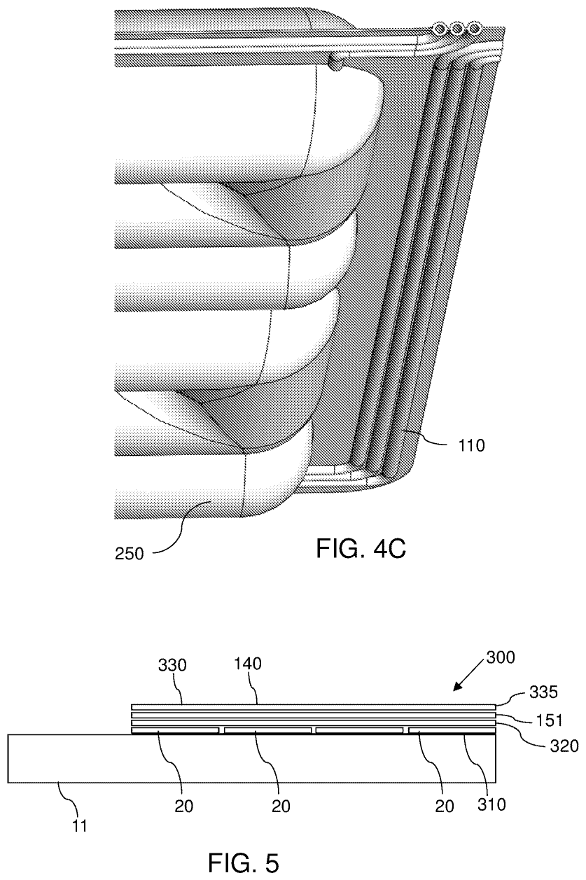

FIG. 5 illustrates a high-level side view of a mattress 300, in accordance with some examples. Mattress 300 is in all respects similar to mattress 200, with the exception that in some examples mattress 200 comprises a plurality of layers. In some examples, mattress 300 comprises a layer 310 and a layer 320.

In some examples, lower face 26 of each inflatable member 20 is in contact with layer 310 and upper face 25 of each inflatable member 20 is in contact with layer 320. In some examples, when one of inflatable members 20 is inflated, upper faces 25 of some of inflatable members 20 are no longer in contact layer 320 since layer 320 is raised. Thus, in some examples, upper faces 25 of all inflatable members 20 are in contact with layer 320 when all inflatable members 20 contain an equal amount of inflation fluid 15. It is noted that this is not limiting to only this case, and upper faces 25 of inflatable members 20 can be in contact with layer 320 even when not all inflatable members 20 contain an equal amount of inflation fluid.

In some examples, layer 310 forms lower faces 26 of inflatable members 20 and layer 320 forms upper faces 25 of inflatable members 20. Thus, in such examples, cavities 30 are defined by layer 310, layer 320 and respective barriers defining the borders between adjacent inflatable members 20.

In some examples, layer 310 and/or layer 320 comprise a layer of padding. In some examples, the padding comprises gel. In some examples, the padding consists essentially of gel. In some examples, the padding comprises foam, such as memory foam. In some examples, the padding consists essentially of foam. In some examples, the padding comprises a combination of foam and gel. In some examples, as described above, the layer of padding is in contact with inflatable members 20.

In some examples, layer 320 comprises padding and is positioned on top of inflatable members 20, as described above. In some examples, the padding of layer 320 exhibits an upper face 321 and a lower face 322 opposing upper face 321. In some examples, lower face 322 faces upper faces 25 of inflatable members 20 and upper face 321 is in contact with temperature adjustment mechanisms 150, i.e. temperature adjustment mechanisms 150 are positioned on top of the padding. In some examples, housing 151 of temperature adjustment mechanism 150 is in contact with upper face 321.

Thus, in some examples, mattress 300 is layered as follows: a layer defined by inflatable members 20, optionally supported below by a layer 310; a layer 320 of padding; and a layer defined by housing 151 of temperature adjustment mechanisms 150. In some examples, an additional layer 330 is provided. In some examples, layer 330 comprises sensors 140. In some examples, layer 330 comprises a patient return electrode 330, such as a diathermy pad. In some examples, the diathermy pad comprises temperature adjustment mechanisms. As known to those skilled in the art, a patient return electrode removes electricity from a patient during a procedure. In some examples, the patient return electrode of layer 330 is contained within a respective padded housing 335. In some examples, sensors 140 are contained within housing 335.

### Some Examples of the Disclosed Implementations

Some examples of above-described implementations are enumerated below. It should be noted that one feature of an example in isolation or more than one feature of the example taken in combination and, optionally, in combination with one or more features of one or more examples below are examples also falling within the disclosure of this application.

Example 1. A mattress for a surgical table, the mattress comprising: a plurality of inflatable members, each of the plurality of inflatable members comprising a respective cavity, wherein each of the plurality of inflatable members is inflatable by injection of inflation fluid into the cavity of the respective inflatable member; and a control circuitry, the inflation of each of the plurality of inflatable members separately responsive to an output of the control circuitry such that the inflation of the respective inflatable member is to a predetermined volume of 0.1-5 liters, wherein at least a sub-set of the plurality of inflatable members are arranged in a 2-dimensional array, wherein the 2-dimensional array exhibits a plurality of rows of the inflatable members and a plurality of columns of the inflatable members, a length of each row being greater than a length of each column.

Example 2. The mattress of any example herein, particularly example 1, wherein, for each of the plurality of inflatable members, the predetermined volume is up to 2 liters.

Example 3. The mattress of any example herein, particularly example 2, wherein the volume of the cavity of each of the plurality of inflatable members when the respective inflatable member is maximally inflated is at least two liters.

Example 4. The mattress of any example herein, particularly example 3, wherein the volume of the cavity of each of the plurality of inflatable members when the respective inflatable member is maximally inflated is about 3 liters.

Example 5. The mattress of any example herein, particularly any one of examples 1-4, wherein the inflation of each of the plurality of inflatable members in the 2-dimensional array is separately responsive to the output of the control circuitry such that a height of the respective inflatable memberis up to about 10 centimeters.

Example 6. The mattress of any example herein, particularly example 5, wherein the inflation of each of the plurality of inflatable members in the 2-dimensional array is separately responsive to the output of the control circuitry such that the height of the respective inflatable member is about 2-10 centimeters.

Example 7. The mattress of any example herein, particularly any one of examples 1-6, wherein the distance between each adjacent pair of the plurality of rows is less than 10 centimeters.

Example 8. The mattress of any example herein, particularly example 7, wherein the distance between each adjacent pair of the plurality of rows is 6-8 centimeters.

Example 9. The mattress of any example herein, particularly any one of examples 1-8, wherein a distance between each adjacent pair of the plurality of columns is less than 5 centimeters.

Example 10. The mattress of any example herein, particularly example 9, wherein the distance between each adjacent pair of the plurality of columns is 1-3 centimeters.

Example 11. The mattress of any example herein, particularly any one of examples 1-10, wherein each of the plurality of inflatable members in the 2-dimensional array exhibits a length of 10-50 centimeters and a width of 10-40 centimeters.

Example 12. The mattress of any example herein, particularly example 11, wherein each of the plurality of inflatable members in the 2-dimensional array exhibits a length of 25-35 centimeters and a width of 15-25 centimeters.

Example 13. The mattress of any example herein, particularly example 11 or 12, wherein a difference between the lengths of the plurality of inflatable members in the 2-dimensional array is less than 10%.

Example 14. The mattress of any example herein, particularly any one of examples 11-13, wherein a difference between the widths of the plurality of inflatable members in the 2-dimensional array is less than 10%.

Example 15. The mattress of any example herein, particularly any one of examples 1-14, wherein a difference between the volumes of the cavities of the plurality of inflatable members in the 2-dimensional array when maximally inflated is less than 10%.

Example 16. The mattress of any example herein, particularly any one of examples 1-15, wherein the 2-dimensional array is rectangular shaped.

Example 17. The mattress of any example herein, particularly any one of examples 1-16, wherein the plurality of rows of inflatable members consists of two or three rows.

Example 18. The mattress of any example herein, particularly example 17, wherein the plurality of rows of inflatable members consists of two rows.

Example 19. The mattress of any example herein, particularly any one of examples 1-18, wherein the plurality of columns of inflatable members consists of 2-4 columns.

Example 20. The mattress of any example herein, particularly any one of examples 1-19, wherein the plurality of inflatable members comprises a headrest member, the 2-dimensional array extending away from the headrest member.

Example 21. The mattress of any example herein, particularly any one of examples 1-20, wherein the control circuitry controls the inflation of each of the plurality of inflatable members in the 2-dimensional array such that a respective area of a patient supported by the respective inflatable member is tilted at a respective tilt angle, the respective tilt angle being 5-22 degrees.

Example 22. The mattress of any example herein, particularly any one of examples 1-21, further comprising a user input terminal, the control circuitry configured to control the inflation of each of the plurality of inflatable members responsive to an output of the user input terminal.

Example 23. The mattress of any example herein, particularly example 22, wherein, responsive to a respective user input at the user input terminal, the control circuitry is configured to prevent the inflation of a respective at least one of the plurality of inflatable members.

Example 24. The mattress of any example herein, particularly example 23, wherein the respective user input comprises an indication of an area of a patient being operated on.

Example 25. The mattress of any example herein, particularly example 23 or 24, wherein, responsive to a respective user input at the user input terminal, the control circuitry is configured to limit an inflation volume of a respective at least one of the plurality of inflation members to a respective upper threshold value greater than zero.

Example 26. The mattress of any example herein, particularly any one of examples 22-25, wherein, responsive to a respective user input at the user input terminal, the control circuitry is configured to prevent the inflation of one or more of the plurality of inflatable members during a predetermined time period.

Example 27. The mattress of any example herein, particularly any one of examples 23-26, further comprising one or more temperature adjustment mechanisms, each configured to adjust a temperature of a respective area of a patient positioned over the plurality of inflatable members.

Example 28. The mattress of any example herein, particularly example 27, wherein the one or more temperature adjustment mechanisms are configured to adjust the temperature of the inflation fluid, the temperature adjustment of the respective area of the patient responsive to an adjustment of the temperature of a respective portion of the inflation fluid.

Example 29. The mattress of any example herein, particularly example 27, wherein the number of the plurality of temperature adjustment mechanisms being at least the number of the plurality of inflatable members, wherein each of the plurality of temperature adjustment mechanisms is juxtaposed with a respective one of the plurality of inflatable members, wherein each of the plurality of temperature adjustment mechanisms is controlled responsive to a respective output of the control circuitry.

Example 30. The mattress of any example herein, particularly any one of examples 27-29, wherein each of the plurality of temperature adjustment mechanisms is configured to provide both cooling and heating.

Example 31. The mattress of any example herein, particularly any one of examples 27-30, further comprising a plurality of sensors, the number of sensors being at least the number of plurality of inflatable members, wherein each of the plurality of sensors is juxtaposed with a respective one of the plurality of inflatable members, and wherein control of the one or more plurality of temperature adjustment mechanisms is responsive to an output of a respective one of the plurality of sensors.

Example 32. The mattress of any example herein, particularly example 31, wherein the plurality of sensors comprises a plurality of humidity sensors.

Example 33. The mattress of any example herein, particularly example 31 or example 32, wherein the plurality of sensors comprises a plurality of pressure sensors.

Example 34. The mattress of any example herein, particularly any one of examples 31-33, wherein the plurality of sensors comprises a plurality of blood perfusion sensors.

Example 35. The mattress of any example herein, particularly any one of examples 31-34, wherein the plurality of sensors comprises a plurality of temperature sensors.

Example 36. The mattress of any example herein, particularly any one of examples 1-35, further comprising a plurality of sensors, the number of the plurality of sensors being at least the number of the plurality of inflatable members, wherein each of the plurality of sensors is juxtaposed with a respective one of the plurality of inflatable members, and wherein control of the inflation of each of the plurality of inflatable members by the control circuitry is responsive to an output of the respective one of the plurality of sensors.

Example 37. The mattress of any example herein, particularly example 36, wherein the plurality of sensors comprises a plurality of humidity sensors.

Example 38. The mattress of any example herein, particularly example 36 or example 37, wherein the plurality of sensors comprises a plurality of pressure sensors.

Example 39. The mattress of any example herein, particularly any one of examples 36-38, wherein the plurality of sensors comprises a plurality of blood perfusion sensors.

Example 40. The mattress of any example herein, particularly any one of examples 36-39, wherein the plurality of sensors comprises a plurality of temperature sensors.

Example 41. The mattress of any example herein, particularly any one of examples 36-40, further comprising a visual indicator.

Example 42. The mattress of any example herein, particularly any one of examples 1-41, further comprising a layer of padding.

Example 43. The mattress of any example herein, particularly example 42, wherein the padding comprises a gel.

Example 44. The mattress of any example herein, particularly example 42 or 43, wherein the layer of padding is in contact with the plurality of inflatable members.

Example 45. The mattress of any example herein, particularly example 44, wherein the layer of padding is positioned on top of the plurality of inflatable members.

Example 46. The mattress of any example herein, particularly example 45, when depending on any one of examples 27-35, wherein the layer of padding exhibits an upper face and a lower face opposing the upper face, and wherein the lower face of the layer of padding faces the plurality of inflatable members and the upper face of the layer of padding is in contact with the plurality of temperature adjustment mechanisms.

Example 47. The mattress of any example herein, particularly any one of examples 1-46, further comprising: a first layer; and a second layer; wherein each of the plurality of inflatable members exhibits an upper face and a lower face opposing the upper face, the lower face of each of the plurality of inflatable members in contact with the first layer, and wherein, when the plurality of inflatable members contain an equal amount of the inflation fluid, the upper face of each of the plurality of inflatable members is in contact with the second layer.

Example 48. The mattress of any example herein, particularly example 47, when depending on example 46, wherein the layer of padding is the second layer.

Example 49. The mattress of any example herein, particularly example 47, when depending on any one of examples 42-45, wherein the layer of padding is the first layer or the second layer.

Example 50. The mattress of any example herein, particularly any one of examples 1-49, further comprising a patient return electrode pad.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention includes both combinations and subcombinations of the various features described hereinabove as well as variations and modifications thereof which would occur to persons skilled in the art upon reading the foregoing description.

1. A mattress for a surgical table, the mattress comprising:
a plurality of inflatable members, each of the plurality of inflatable members comprising a respective cavity, wherein each of the plurality of inflatable members is inflatable by injection of inflation fluid into the cavity of the respective inflatable member; and
a control circuitry, the inflation of each of the plurality of inflatable members separately responsive to an output of the control circuitry such that the inflation of the respective inflatable member is to a predetermined volume of 0.1-5 liters,
wherein at least a sub-set of the plurality of inflatable members are arranged in a 2-dimensional array, and
wherein the 2-dimensional array exhibits a plurality of rows of the inflatable members and a plurality of columns of the inflatable members, a length of each row being greater than a length of each column.

2. The mattress of claim 1, further comprising a user input terminal, the control circuitry configured to control the inflation of each of the plurality of inflatable members responsive to an output of the user input terminal.

3. The mattress of claim 2, wherein, responsive to a respective user input at the user input terminal, the control circuitry is configured to prevent the inflation of a respective at least one of the plurality of inflatable members.

4. The mattress of claim 3, wherein the respective user input comprises an indication of an area of a patient being operated on.

5. The mattress of claim 3, wherein, responsive to a respective user input at the user input terminal, the control circuitry is configured to limit an inflation volume of a respective at least one of the plurality of inflation members to a respective upper threshold value greater than zero.

6. The mattress of claim 2, wherein, responsive to a respective user input at the user input terminal, the control circuitry is configured to prevent the inflation of one or more of the plurality of inflatable members during a predetermined time period.

7. The mattress of claim 3, further comprising one or more temperature adjustment mechanisms, each configured to adjust a temperature of a respective area of a patient positioned over the plurality of inflatable members.

8. The mattress of claim 7, wherein the one or more temperature adjustment mechanisms are configured to adjust the temperature of the inflation fluid, the temperature adjustment of the respective area of the patient responsive to an adjustment of the temperature of a respective portion of the inflation fluid.

9. The mattress of claim 7, wherein the number of the plurality of temperature adjustment mechanisms being at least the number of the plurality of inflatable members,
wherein each of the plurality of temperature adjustment mechanisms is juxtaposed with a respective one of the plurality of inflatable members,
wherein each of the plurality of temperature adjustment mechanisms is controlled responsive to a respective output of the control circuitry.

10. The mattress of claim 7, wherein each of the plurality of temperature adjustment mechanisms is configured to provide both cooling and heating.

11. The mattress of claim 7, further comprising a plurality of sensors, the number of sensors being at least the number of plurality of inflatable members,
wherein each of the plurality of sensors is juxtaposed with a respective one of the plurality of inflatable members, and
wherein control of the one or more plurality of temperature adjustment mechanisms is responsive to an output of a respective one of the plurality of sensors.

12-15. (canceled)

16. The mattress of claim 1, further comprising a plurality of sensors, the number of the plurality of sensors being at least the number of the plurality of inflatable members,
wherein each of the plurality of sensors is juxtaposed with a respective one of the plurality of inflatable members, and
wherein control of the inflation of each of the plurality of inflatable members by the control circuitry is responsive to an output of the respective one of the plurality of sensors.

17. The mattress of claim 16, wherein the plurality of sensors comprises a plurality of humidity sensors and/or a plurality of pressure sensors.

18. (canceled)

19. The mattress of claim 16, wherein the plurality of sensors comprises a plurality of blood perfusion sensors and/or a plurality of temperature sensors.

20-22. (canceled)

23. The mattress of claim 16, wherein the volume of the cavity of each of the plurality of inflatable members when the respective inflatable member is maximally inflated is at least two liters.

24. (canceled)

25. The mattress of claim 1, wherein the inflation of each of the plurality of inflatable members in the 2-dimensional array is separately responsive to the output of the control circuitry such that a height of the respective inflatable member is up to about 10 centimeters.

26-30. (canceled)

31. The mattress of claim 1, wherein each of the plurality of inflatable members in the 2-dimensional array exhibits a length of 10-50 centimeters and a width of 10-40 centimeters.

32-36. (canceled)

37. The mattress of claim 1, wherein the plurality of rows of inflatable members consists of two or three rows.

38. (canceled)

39. The mattress of claim 1, wherein the plurality of columns of inflatable members consists of 2-4 columns.

40. (canceled)

41. The mattress of claim 1, wherein the control circuitry controls the inflation of each of the plurality of inflatable members in the 2-dimensional array such that a respective area of a patient supported by the respective inflatable member is tilted at a respective tilt angle, the respective tilt angle being 5-22 degrees.

42-50. (canceled)
